(19) United States
(12) Patent Application Publication
(10) Pub. No.: US 2009/0123196 A1
(43) Pub. Date: May 14, 2009

(54) IMAGE FORMING APPARATUS

(75) Inventors: Yoshihisa NAKAO, Ebina-shi (JP); Masao OHKUBO, Ebina-shi (JP); Yoshihiro ENOMOTO, Ebina-shi (JP); Shinichi KAWAMATA, Ebina-shi (JP); Kazumi YAMANAKA, Ebina-shi (JP); Masaaki TOKUNAGA, Ebina-shi (JP); Hirofumi GOTO, Ebina-shi (JP); Kazuyoshi HAGIWARA, Ebina-shi (JP); Hiroaki YAGI, Ebina-shi (JP); Masatoshi YAMADA, Ebina-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/120,361

(22) Filed: May 14, 2008

(30) Foreign Application Priority Data
Nov. 14, 2007 (JP) 2007-296028

(51) Int. Cl. G03G 15/01

(52) U.S. Cl. 399/301

(57) ABSTRACT

An image forming apparatus includes: an endless intermediate transferring belt to which a toner image is transferred; a reference position marking member that is formed on a surface of the intermediate transferring belt, and that shows a reference position in a circumferential direction of the intermediate transferring belt; a detecting unit that detects the reference position marking member; and a control unit that controls the intermediate transferring belt to stop at a position where the reference position marking member is exposed to outside in a case where an outer cover is opened.

### CROSS-REFERENCE TO RELATED APPLICATIONS

This application is based on and claims priority under 35 U.S.C. 119 from Japanese Patent Application No. 2007-296028 filed Nov. 14, 2007.

### BACKGROUND

1. Technical Field

This invention relates to an image forming apparatus.

2. Related Art

Traditionally, as such a kind of image forming apparatus, there has been proposed a tandem image forming apparatus in which after toner images of the respective colors formed by four image forming sections of yellow (Y), magenta (M), cyan (C) and black (K) are transferred to an intermediate transferring belt arranged above or below these four image forming sections, the toner images superposedly transferred on the intermediate transferring belt are collectively secondary-transferred on a recording medium and fixed, thereby forming a full-color image.

Further, as the above image forming apparatus, there has been also proposed a four-cycle image forming apparatus provided with a single image forming section for successively forming four color images of yellow (Y), magenta (M), cyan (C) and black (K), in which after toner images of the respective colors of yellow (Y), magenta (M), cyan (C) and black (K) successively formed by the single image forming section are transferred to an intermediate transferring belt arranged below the image forming section, the toner images superposedly transferred to the intermediate transferring belt are collectively secondary-transferred to a recording medium and fixed, thereby forming a full-color image.

Meanwhile, in these image forming apparatuses, in the case of the image forming apparatus using the intermediate transferring belt with both ends of a belt-like member connected to each other or the above four cycle image forming apparatus, for necessity of detecting an image-forming starting position on the intermediate transferring belt in order to form an image away from the seam being an connecting position of the intermediate transferring belt or to superpose the four color toner images on the intermediate transferring belt, a reference mark is provided at the end in the width direction on the surface of the intermediate transferring belt by the means such as bonding.

The above reference mark is employed for not only detecting the image-forming starting position on the intermediate transferring belt, but also detecting occurrence of abnormality such as holes or cracks on the intermediate transferring belt, detecting the expansion/contraction of the intermediate transferring belt due to changes in the environment such as temperature and humidity thereby to adjust the feeding timing of a sheet of paper to the secondary transferring position on the intermediate transferring belt, shortening the time taken for starting the first image forming operation, and controlling the stopping position of the intermediate transferring belt in order to prevent the intermediate transferring belt from making a curling tendency.

As the above reference mark, a sealing member whose surface is silver to provide a high reflectance of light is employed. In the above image forming apparatuses, the reference mark is detected by a reflective sensor composed of a light emitting element and a light receiving element.

However, in the image forming apparatus using the above reference mark, if the surface of the reference mark is contaminated with floating toners, the detecting sensitivity of the reflective sensor is attenuated so that malfunction due to erroneous detection of the reference mark may occur.

### SUMMARY

According to an aspect of the present invention, an image forming apparatus includes: an endless intermediate transferring belt to which a toner image is transferred; a reference position marking member that is formed on a surface of the intermediate transferring belt, and that shows a reference position in a circumferential direction of the intermediate transferring belt; a detecting unit that detects the reference position marking member; and a control unit that controls the intermediate transferring belt to stop at a position where the reference position marking member is exposed to outside in a case where an outer cover is opened.

### BRIEF DESCRIPTION OF THE DRAWINGS

Exemplary embodiment of the present invention will be described in detail based on the following figures, wherein:

FIG. 1 is a schematic view of a tandem full-color composite machine serving as an image forming apparatus according to the first embodiment of this invention;

FIG. 2 is a view showing the entire arrangement of a tandem full-color composite machine serving as an image forming apparatus according to the first embodiment of this invention;

FIG. 3 is a view showing an image forming portion of a tandem full-color composite machine serving as an image forming apparatus according to the first embodiment of this invention;

FIG. 4 is an enlarged view showing an image forming portion of a tandem full-color composite machine serving as an image forming apparatus according to the first embodiment of this invention;

FIG. 5 is a view showing the stretched state of an intermediate transferring belt;

FIG. 6 is a perspective view of a part of the intermediate transferring belt;

FIGS. 7A and 7B are views showing a reflective optical sensor and an output signal, respectively;

FIG. 8 is a timing chart showing the output signal from a reflective optical sensor in a normal state;

FIGS. 9A and 9B are views showing the side of the intermediate transferring body unit, respectively;

FIG. 10 is a perspective view showing the attaching/detaching mechanism of an intermediate transferring body unit;

FIG. 11 is a perspective view showing the attached/detached state of an intermediate transferring body unit;

FIG. 12 is a perspective view of the state where an outer cover and a front cover are opened;

FIG. 13 is a table showing the stopping time of the intermediate transferring belt when detection failure of the reflective optical sensor occurs;

FIG. 14 is a perspective view showing the stopped state of the intermediate transferring belt; and

FIG. 15 is a timing chart showing an output signal from the reflective optical sensor when detection failure occurs.

### DETAILED DESCRIPTION

Now referring to the drawings, an explanation will be given of embodiments of this invention.

### Embodiment 1

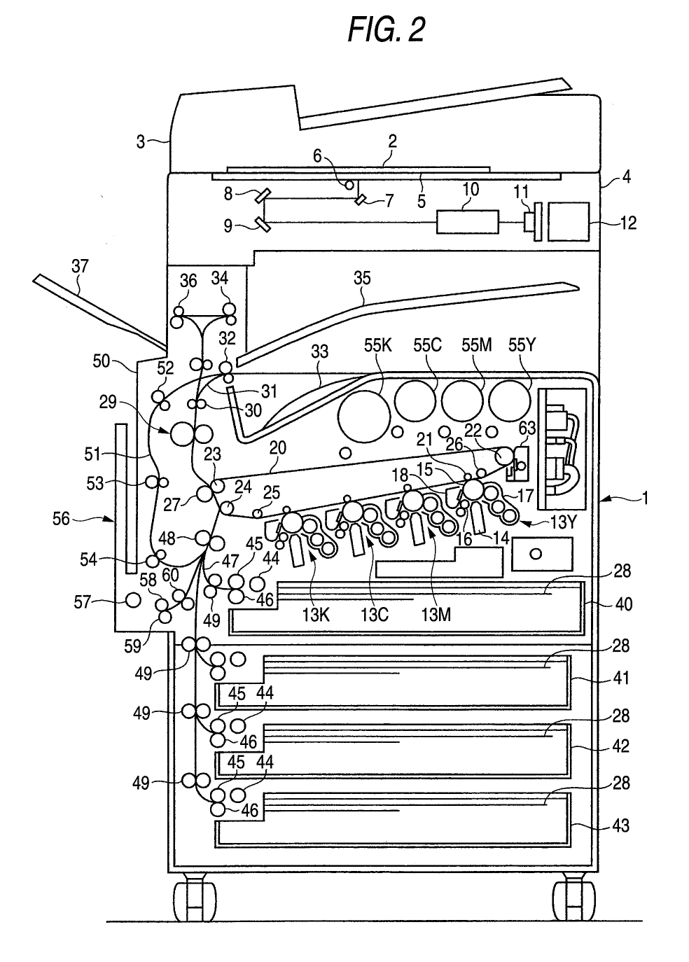

FIG. 2 shows a tandem digital color composite machine serving as an image forming apparatus according to the first embodiment. This tandem digital color composite machine is provided with an image reading device, but may be a printer not provided with the image reading device.

Referring to FIG. 2, reference numeral 1 denotes a body of the tandem digital color composite machine (also simply referred to as a composite machine body). In the upper portion of the composite machine body 1, arranged are an automated document feeding device 3 which automatically feed documents 2 in a state separated one by one, and a document reading device 4 which reads an image of the document fed by the automated document feeding device 3. In the document reading device 4, the document 2 placed on a platen glass 5 is illuminated by a light source 6 and an optical image reflected from the document 2 is scanning-exposed onto an image reading element 11 of CCD through a miniature optical system composed of a full-rate mirror 7, half-rate mirrors 8, 9 and an imaging lens 10 so that the reflected optical image of the document 2 is read with a prescribed dot density (e.g. 16 dots/mm) by the image reading element 11.

The reflected optical image read by the document reading device 4 is supplied as document reflectance data of three colors of e.g. red (R), green (G) and blue (B) (8 bits for each color) to an image processing device 12. In this image processing device 12, the reflectance data of the document 2 is subjected to image processing such as shading correction, misregistration correction, lightness/color-space conversion, gamma correction, frame cancellation and color/moving edition. The image processing device 12 performs the image processing for also the image data (image information) transmitted from a personal computer and a telephone line (not shown).

The image data subjected to the predetermined image processing by the image processing device 12 as described above are converted into four color gradation data of yellow (Y), magenta (M), cyan (C) and black (K) (8 bits for each color) by the same image processing device 12. The four color gradation data thus converted are sent to an image light-exposing device 14 composed of image forming units 13Y, 13M, 13C and 13K of the respective colors of yellow (Y), magenta (M), cyan (C) and black (K) as described below. In this image light-exposing device 14, the light exposure is carried out by the light emitted by an LED light emitting array according to the gradation data of the document 2 of a predetermined color.

Meanwhile, in this embodiment, the image forming apparatus includes plural image forming sections which form toner images with different colors and a belt-like intermediate transferring body arranged over the plural image forming units in a state inclined with respect to a horizontal direction, on which the toner images are transferred by the plural image forming sections.

Inside the above tandem digital color composite machine body 1, as shown in FIG. 2, four image forming units (image forming sections) 13Y, 13M, 13C and 13K of yellow (Y), magenta (M), cyan (C) and black (K) are arranged in parallel at regular intervals in the state inclined by a prescribed angle with respect to the horizontal direction so that in a vertical direction, the image forming unit 13Y of the first color, yellow (Y) is higher and the image forming unit 13K of the last color, black (K) is relatively low.

In this way, by arranging the four image forming units 13Y, 13M, 13C and 13K of yellow (Y), magenta (M), cyan (C) and black (K) in the state inclined by the prescribed angle, as compared with the case where these four image forming units 13Y, 13M, 13C and 13K are arranged horizontally, the installing distance in the width direction can be shortened. This permits the width of the composite machine body 1 to be shortened, thereby downsizing the image forming apparatus.

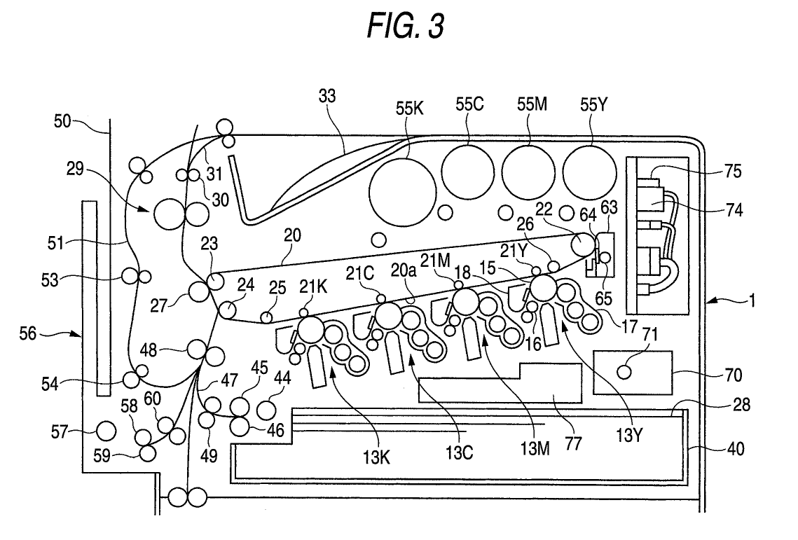

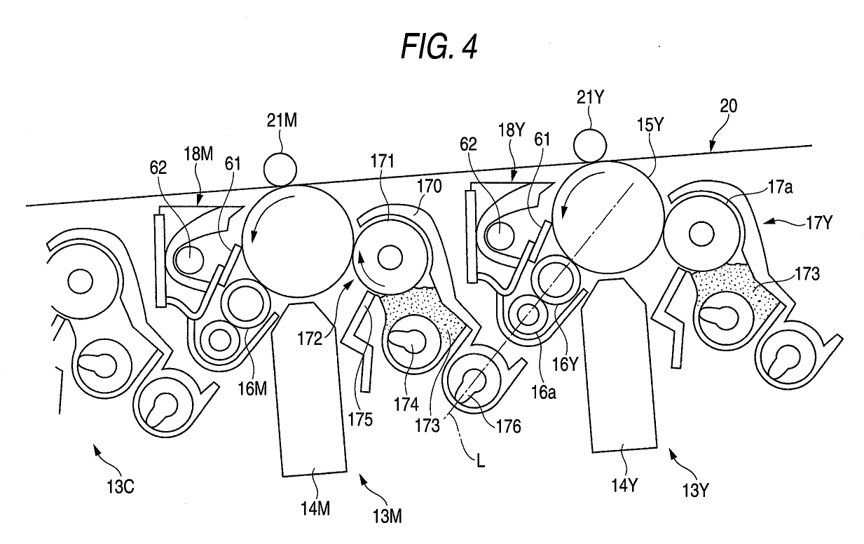

These four image forming units 13Y, 13M, 13C and 13K are constructed in basically the same manner. As shown in FIGS. 3 and 4, the image forming unit mainly includes a photosensitive drum 15 serving as an image carrier which is rotationally driven at a prescribed speed by a driving unit (not shown); a charging roll 16 for primary charging which uniformly charges the surface of the photosensitive drum 15; an image light-exposing device 14 formed of an LED print head which light-exposes the image corresponding to a predetermined color thereby to form an electrostatic latent image on the surface of the photosensitive drum 15; a developer 17 which develops the electrostatic latent image on the surface of the photosensitive drum 15 with the toners of a predetermined color; and a cleaning device 18 which cleans the surface of the photosensitive drum 15.

The photosensitive drum 15 may be for example, an organic photosensitive body which is formed in a drum shape with a diameter of 30 mm and having an overcoat layer on the surface. The photosensitive drum 15 is rotationally driven at a prescribed rotary speed by a driving motor (not shown).

Further, the charging roll 16 may be for example, a roll-like charger coated with a conductive layer of synthetic resin or rubber with adjusted electric resistance on the surface of a core. The core of the charging roll 16 may be supplied with predetermined charging bias. On the surface of the charging roll 16, a cleaning roll 16a for removing the foreign material such as toners applied on the surface of the charging roll 16 is arranged to be in contact therewith.

The image light-exposing device 14, as shown in FIGS. 3 and 4, is individually arranged for each of the four image forming units 13Y, 13M, 13C and 13K. The image light-exposing 14 provided for each of the four image forming units 13Y, 13M, 13C and 13K is provided with an LED light-emitting element array consisting of LED light emitting elements arranged linearly at a predetermined pitch (e.g. 600 dpi) and a CELLFOX LENZ (trade name) array which images the light emitted from each LED emitting element of the LED light element array as spots on the photosensitive drum. The image light-exposing device 14, as shown in FIG. 2, is adapted to scanning-expose the image on the photosensitive drum 15 from below.

From the image processing device 12, the image data of each color are successively supplied to the image light-exposing device 14Y, 14M, 14C, 14K provided in the image forming unit 13Y, 13M, 13C, 13K of each color of yellow (Y), magenta (M), cyan (C), black (K). The light beam emitted according to the image data from the image light-exposing device 14Y, 14M, 14C, 14K are put on the corresponding photosensitive drum 15 thereby to form the latent image. The latent image formed on the photosensitive drum 15 is developed as the toner image of each color of yellow (Y), magenta (M), cyan (C), black (K) by the developer 17Y, 17M, 17C, 17K.

The toner image of each color of yellow (Y), magenta (M), cyan (C), black (K) sequentially formed on the photosensitive drum 15 of each image forming unit 13Y, 13M, 13C, 13K is superposedly transferred by a primary transferring roll 21Y, 21M, 21C, 21K to an intermediate transferring belt 20 serving as an endless belt-like intermediate transferring body arranged in an inclined sate over each image forming unit 13Y, 13M, 13C, 13K.

The intermediate transferring belt 20 is an endless belt-like member stretched by plural rolls. The intermediate transferring belt 20 is arranged in a state inclined with respect to the horizontal direction so that the lower side traveling area of the endless belt-like member is lower at the downstream side along the traveling direction and higher at the upstream side.

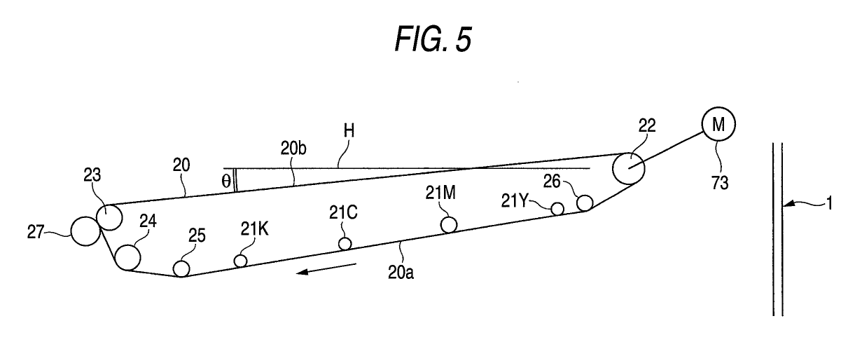

Specifically, the intermediate transferring belt 20, as shown in FIG. 5, is routed with a predetermined tension among a drive roll 22 which is rotationally driven by a driving motor 73 such as a stepping motor, a backup roll 23, a tension roll 24, a sensor roll 25 and a position roll 26. The intermediate transferring belt 20 is circularly driven by the drive roll 22 rotationally driven at a prescribed speed in a direction of arrow by the driving motor 73 with excellent constant speed performance. The intermediate transferring belt 20 may be made of a synthetic resin film of e.g. flexible polyimide formed in a belt shape, whose both ends are connected by the means such as welding to provide an endless belt shape. The intermediate transferring belt 20 may also be a “seamless” belt with no connecting region. The intermediate transferring belt 20 is arranged so that its lower side traveling region 20a is in contact with the photosensitive drum 15Y, 15M, 15C, 15K of each image forming unit 13Y, 13M, 13C, 13K.

Further, in the intermediate transferring belt 20 as shown in FIG. 5, a secondary transferring roll 27 is located at the lower side end of an upper side traveling region 20b of the intermediate transferring belt 20 arranged in the state inclined by an angle θ with respect to the horizontal direction H. The secondary transferring roll 27 serves as a secondary transferring unit which secondarily transfers the toner image primarily transferred on the intermediate transferring belt 20 onto a recording medium. The secondary transferring roll 27 is in contact with the surface of the intermediate transferring belt 20 stretched by the backup roll 23.

The toner image of each color of yellow (Y), magenta (M), cyan (C), black (K) superposedly transferred on the intermediate transferring belt, as shown in FIGS. 2 and 3, is transferred to a recording sheet 28 serving as the recording medium with pressure-contact force and electrostatic force by the secondary transferring roll 27 being in pressure-contact with the backup roll 23. The recording sheet 28 with the toner image of each color transferred thereto is fed to a fixer 29 located above in the vertical direction. The secondary transferring roll 27 is in pressure-contact with the side of the backup roll 23 so that it secondarily transfers the toner image of each color onto the recording sheet 28 which is transported from below to above in the vertical direction. The recording sheet 28 with the toner image of each color transferred thereto is subjected to fixing processing by heat and pressure by the fixer 29. Thereafter, the recording sheet 28 is exhausted onto a first discharge tray 33 arranged on the upper portion of the body 1 by a first discharge roll 32 through an outlet roll 30 of the fixer 29 and a sheet discharge path 31, onto a second discharge tray 35 arranged above the body 1 by a second roll 34, or otherwise onto a third face-up tray 37 arranged aside of the body 1 by a third exhaust tray 36.

The recording sheet 28 having a prescribed size, as shown in FIG. 2, is once transported from a sheet feeding tray 40 serving as a recording medium housing vessel arranged within the composite machine body 1 or sheet feeding trays 41 to 43 arranged at the lower portion of the composite machine body 1 to a resist roll 48 by a sheet feeding roller 44 and a pair of rollers 45, 46 for separated transportation of the sheet through a transporting roll 49 and a sheet transporting path 47, and stopped there. The recording sheet 28 fed by any of the sheet feeding trays 40 to 43 is sent out to the secondary transferring position of the intermediate transferring belt 20 by the resist roll 48 which rotates at a prescribed timing.

In the above digital color printer and copying machine, where a double-sided copy of e.g. full color is taken, the recording sheet 28 with the image fixed on the one side, as it is, is not discharge d onto the first discharge tray 33 by the first discharge roll 32, but transported to a double-sided transporting unit 50 by switching the transporting direction by a switching gate (not shown) while the rear end of the recording sheet 28 is pinched by the first discharge roll 32. In the double-sided transporting unit 50, the recording sheet 28 in a state turned inside out is transported to the resist roll 48 again by pairs of transporting rollers 52 to 54 provided along the transporting path 51. This time, the recording sheet 28, after the image is transferred and fixed on the rear face thereof, is discharge d onto any of the first exhaust tray 33 to the third discharge tray 37.

In FIG. 2, reference numeral 55Y, 55M, 55C, 55K denotes a toner cartridge which supplies the toners of a predetermined color to the developer 17 for each color of yellow (Y), magenta (M), cyan (C), black (K). The toner cartridge housing the toners of black (K), which is more frequently employed, is formed in a larger size than that of the other toner cartridges of the other colors.

Further, in FIG. 2, reference numeral 56 denotes a manual feeding tray in a folded state, from which the recording medium 28 having a desired substance and a prescribed size is transported to the resist roll 48 by a sheet feeding roller 57 and a pair of rollers 58, 59 through the transporting roll 60 for separated transportation of the sheet.

FIG. 4 shows each image forming unit of the above digital color composite machine.

All the above four image forming units 13Y, 13M, 13C and 13K of yellow, magenta, cyan and black, as shown in FIG. 4, are constructed in the same configuration. In these four image forming units 13Y, 13M, 13C and 13K, as described above, the respective toner images of yellow, magenta, cyan and black are successively formed at predetermined timings. The image forming unit 13Y, 13M, 13C, 13K of each color, as described above, is provided with the photosensitive drum 15. The surface of the photosensitive drum 15 is uniformly charged by the charging roll 16 for primary charging. Thereafter, the surface of the photosensitive drum 15 is light-exposed by scanning with the light beam emitted according to the image data from the image light-exposing device 14 to form the electrostatic latent image corresponding to each color. The light beam put on the photosensitive drum 15 is put at a prescribed angle in a direction of slightly rightward and obliquely below from the position immediately below the photosensitive drum 15. The electrostatic latent image formed on the photosensitive drum 15 is developed with the toners of each color of yellow, magenta, cyan, black by a developing roll 171 of the developer 17 of each image forming unit 13Y, 13M, 13C, 13K to provide a visible toner image. The visible toner image is superposedly transferred on the intermediate transferring belt 20 by charging of the primary transferring roll 21. The developing roll 171 of the developer 17 is arranged at an opening 172 located on the photosensitive drum 15 side of a developer housing 170. Behind the developing roll 171, arranged are a supplying auger 174 which supplies a developing agent 173 to the developing roll 171 and a stirring auger 176 which supplies the developing agent to the supplying auger 174 while stirring it. The layer thickness of the developing agent 173 supplied to the surface of the developing roll 171 is limited to a predetermined value by a layer thickness member 175.

Each developer 17Y, 17M, 17C, 17K adopts a two-component developing system using the developer consisting of two components of a toner and carrier, in which a magnetic brush of the two-component developer consisting of the toner and carrier is formed on the surface of the developing roll 171 thereby to develop the electrostatic latent image formed on the surface of the photosensitive drum 15Y, 15M, 15C, 15K of the corresponding color.

After the step of transferring the toner image is completed, the residual toners and paper power on the surface of the photosensitive drum 15 are eliminated by the cleaning device 18. Then, the surface of the photosensitive drum 15 is prepared for the subsequent image forming process. The cleaning device 18 is equipped with a cleaning blade 61 for eliminating the waste toners on the photosensitive drum 15. The waste toners eliminated by the cleaning blade 61 are transported to the front side of the copying machine body 1 at a prescribed timing by a transporting auger 62 provided within the cleaning device 18 and transported to a waste toner recovery vessel through a pipe for transportation (not shown).

After the step of transferring the toner image is completed, as shown in FIG. 3, the residual toners and paper power on the surface of the intermediate transferring belt 20 are eliminated by the cleaning blade 64 of a cleaning device 63. Then, the surface of the intermediate transferring belt 20 is prepared for the subsequent image forming process. The waste toners eliminated by the cleaning blade 64 of the cleaning device 63 are transported to the front side of the copying machine body 1 at a prescribed timing by a transporting auger 65 provided within the cleaning device 63 and transported to a waste toner recovery vessel through a pipe for transportation (not shown).

Meanwhile, the image forming apparatus according to this embodiment includes an endless intermediate transferring belt to which a toner image is transferred according to image information; a reference position detecting member formed on the surface of the intermediate transferring belt, which is used to detect the reference position in a circumferential direction of the intermediate transferring belt; a detecting unit for detecting the reference position detecting member provided on the surface of the intermediate transferring belt; and a control unit for controlling the stopping position of the intermediate transferring belt so that the intermediate transferring belt always stops at a position where the reference position detecting member formed on the surface of the intermediate transferring belt is exposed to the outside when an outer cover opens regardless of whether or not a detection signal outputted from the detecting unit is normally outputted.

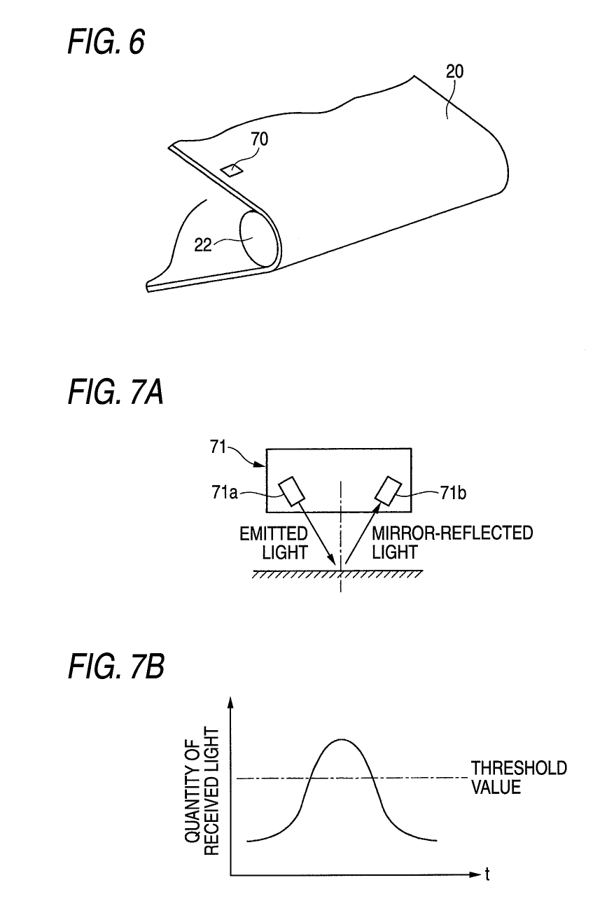

Specifically, in this embodiment, as shown in FIG. 6, on the surface at the one end along the width direction orthogonal to the moving direction of the intermediate transferring belt 20, a reference seal 70 is provided by the means such as bonding. The reference seal 70 serves as a reference position marking member for showing the reference position in the circumferential direction of the intermediate transferring belt 20. The reference seal 70 is a seal member with glue or adhesive put on the rear surface and being silver providing a high light reflectance on the front surface. The reference seal 70 is formed in a square shape with sides of 7 mm.

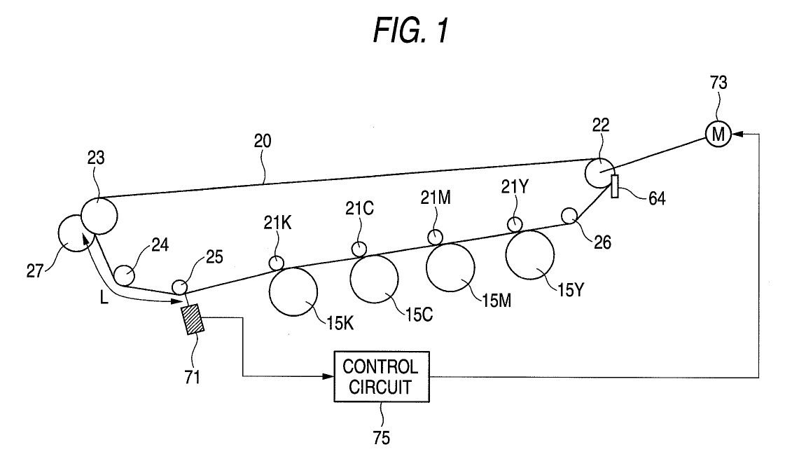

Further, as shown in FIG. 1, a reflective optical sensor 71 is provided on the body 1 side of the digital color multi function machine. The reflective optical sensor 71 serves as a detecting unit for detecting the reference seal 70 formed on the surface of the intermediate transferring belt 20. The reflective optical sensor 71, for example as shown in FIG. 7, includes a light emitting element 71a of e.g. LED and a light receiving element 71b of e.g. a photodiode. In this reflective optical sensor 71, the incidence angle of illumination light which is put on the surface of the intermediate transferring belt 20 by the light emitting element 71a is equal to the emanating angle of the reflection light mirror-reflected from the surface of the intermediate transferring belt 20 to be incident on the light receiving element 71b. When the reference seal 70 with silver providing high light reflectance on the front surface passes, the mirror-reflected light of the illumination light emitted from the light emitting element 71a is received by the light receiving element 71b. In this way, the reflective optical sensor 71 detects the reference seal 70. The output signal when the reference seal 70 is detected by the reflective optical sensor 71 varies as shown FIG. 7B. Thus, by comparing the output signal from the reflective optical sensor 71 with a prescribed threshold value, the position of the reference seal 70 can be detected.

The above reflective optical sensor 71, as shown in FIG. 1, is arranged on the upstream side by a prescribed distance L from the secondary transferring position along the moving direction of the intermediate transferring belt 20 in a moving path along which the intermediate transferring belt 20 is circularly driven. At the position where the reflective optical sensor 71 is arranged, a sensor roll 25 is provided which is kept in contact with the rear side of the intermediate transferring belt 20 in order to keep constant the interval between the intermediate transferring belt 20 and the reflective optical sensor 71.

While the intermediate transferring belt 20 is clockwise circularly driven by the drive roll 22 at a prescribed speed, the reference seal 70 formed on the surface of the intermediate transferring belt 20 is detected by the reflective optical sensor 71 so that the stopping position of the intermediate transferring belt 20 is controlled by a control circuit 75 of CPU serving as a control unit.

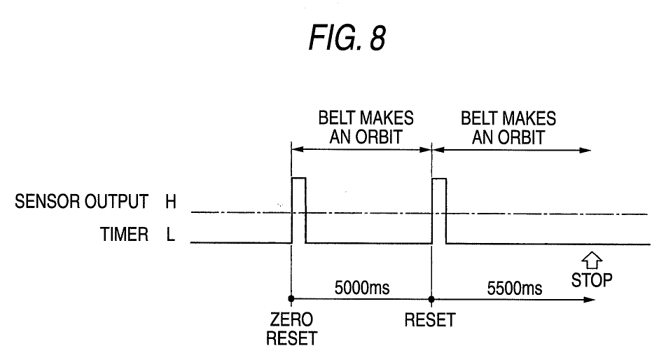

The control circuit 75 is provided with a timer circuit. When an output signal from the reflective sensor 71 is inputted, as shown in FIG. 8, the timer circuit starts counting in the reset state. When the subsequent output signal is inputted from the reflective sensor 71, the timer circuit starts counting again in the reset state. The circumferential length of the intermediate transferring belt 20 is set at e.g. about 872 mm. The moving speed of the intermediate transferring belt 20 is set at e.g. 175 mm/sec. Thus, the detected signal of the reference seal 70 is outputted from the reflective optical sensor 71 once every 5000 msecs=872 mm/175 mm/sec.

The moving speed of the intermediate transferring belt 20 can be set at not only 175 mm/sec but also 121 mm/sec for a thick sheet and 79 mm/sec for a thicker sheet.

The control circuit 75 starts the counting by the timer circuit on the basis of the output signal from the reflective optical sensor 71 thereby to control the stopping position of the intermediate transferring belt 20.

However, while the above digital color composite machine is employed for a long time, or while the printing operation of a very large number of sheets is carried out, the surface of the reference seal 70 may be contaminated with the toners or the like so that the reference seal 70 cannot be detected precisely by the reflective optical sensor 71, thereby generating detection failure.

In this way, when detection failure of the reference seal 70 by the reflective optical sensor 71 is generated, the control circuit 75, as it is, cannot stop the intermediate transferring belt 20 at a prescribed position.

In order to obviate such inconvenience, in this embodiment, the control circuit 75 makes control of always stopping the intermediate transferring belt 20 at a position where the reference seal 70 formed on the surface of said intermediate transferring belt 20 is exposed to the outside when an outer cover of the digital color multi function machine is opened.

Meanwhile, in this embodiment, the intermediate transferring belt 20 is integrally constructed as an intermediate transferring body unit 80 as well as the drive roll 22, backup roll 23, tension roll 24, sensor roll 25, position roll 26, etc. which stretch the intermediate transferring belt 20. The intermediate transferring body unit 80 is made attachable/detachable from the one side of the multi function machine body 1 (left side in the illustrated example).

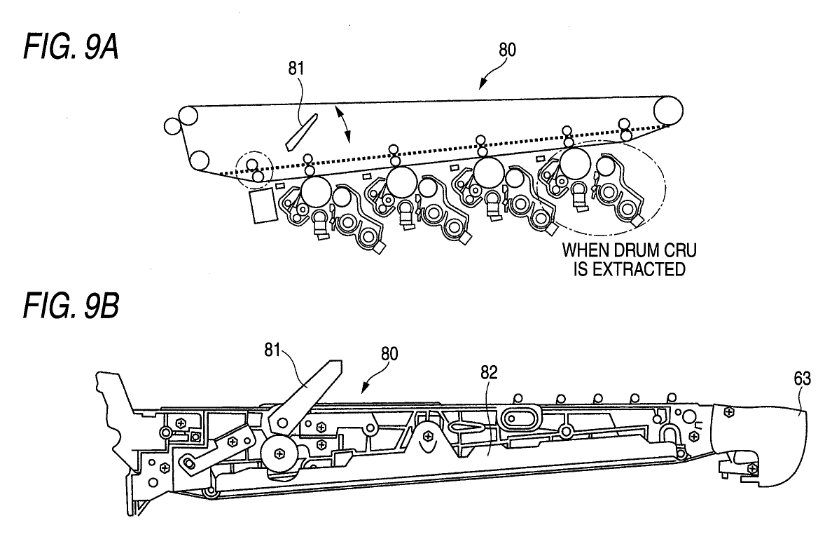

The intermediate transferring body unit 80, as shown in FIG. 9A, is designed to separate the intermediate transferring belt 20 from the photosensitive drum 15 of each image forming unit 13Y, 13M, 13C, 13K by upward retracting the first idler roll 25, second idler roll 26 and each primary transfer roll 21Y, 21M, 21C, 21K through the rotation-driving of a retract handle 81 provided in the intermediate transferring body unit 80.

More specifically, as shown in FIG. 9B, the retract handle 81 is rotation-movably attached to the intermediate transferring unit 80. A holding frame 82, to which the first idler roll 25, second idler roll 26 and each primary transfer roll 21Y, 21M, 21C, 21K are rotatably attached, is coupled with the retract handle 81 through a link mechanism (not shown). Thus, by the rotation-driving of the retract handle 81, the holding frame 82 move vertically so that the intermediate transferring belt 20 can be separated from the photosensitive drum 15 of each image forming unit 13Y, 13M, 13C, 13K.

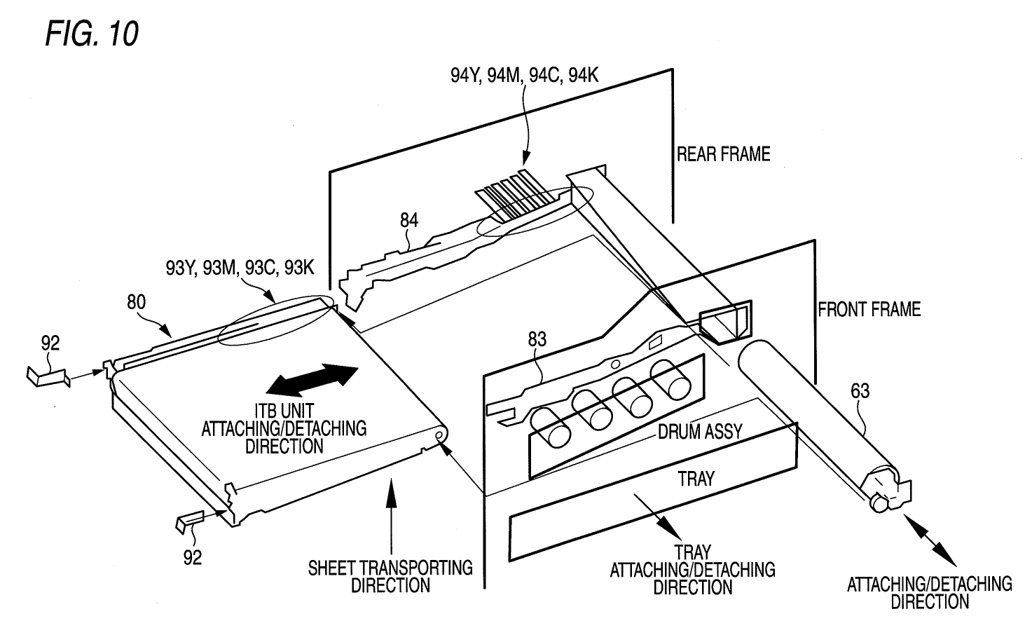

Further, within the above digital color multi function machine body 1, as shown in FIG. 10, guide rails 83, 84 are provided which serve to detachably guide the intermediate transferring body unit 80 toward the one side of the machine body 1. The guide rails 83, 84 are set to change the direction of guiding the intermediate transferring body unit 80 on the way. The guide rails 83, 84 are provided on both front and rear sides of the multi function machine body 1, respectively.

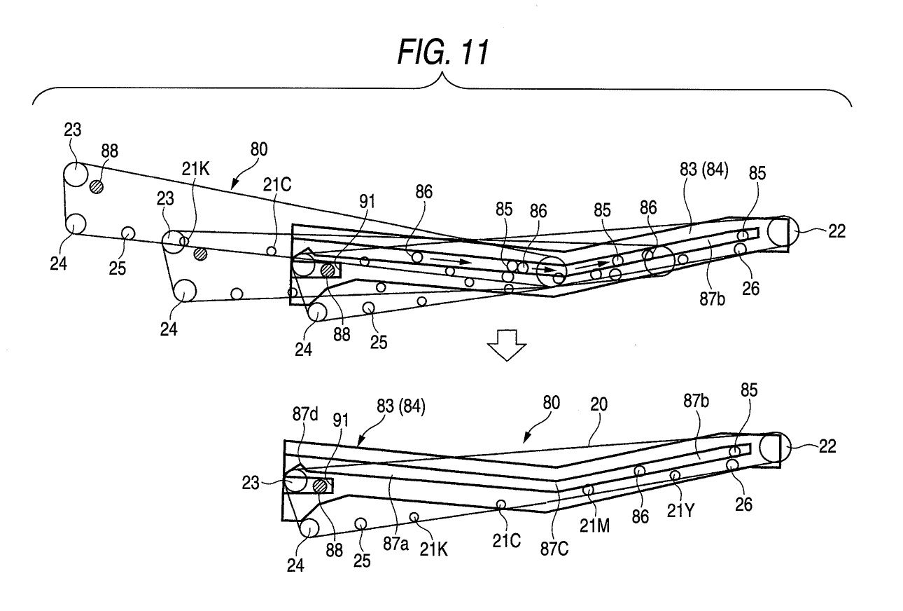

The guide rail 83, 84, as shown in FIG. 11, is provided with a guide groove 87 which is engaged with two guide pins 85, 86 attached to the intermediate transferring body unit 80 to guide the intermediate transferring body unit 80. The guide groove 87 of the guide rail 83, 84 includes a first segment 87a and a second segment 87b. The first segment 87a is oriented in a horizontal direction of guiding the intermediate transferring body unit 80 when it is attached in or detached from the multi function machine body 1 or in a direction inclined with respect to the horizontal direction so that its left end becomes slightly high. The second segment 87b is oriented in a direction inclined so that the right end becomes high by a prescribed height, the direction being a direction of guiding the intermediate transferring belt 20 of the intermediate transferring body unit 80 to an operating position of the machine body 1. The first segment 87a and second segment 87b are connected to each other through a knee 87c. It is needless to say that the first segment 87a and the second segment 87b may be connected to each other through a curve smoothly bent.

On the other hand, in the intermediate transferring body unit 80, on the side walls on the front side and rear side, the guide pins 85, 86 for guiding the intermediate transferring body unit 80 are provided to project outwardly at a position in the vicinity of the end on the drive roll side of the intermediate transferring body unit 80 and an intermediate position by a prescribed distance apart therefrom. Further, in the intermediate transferring body unit 80, on the side walls on the front side and rear side, positioning pins 88 for positioning the intermediate transferring body unit 80 are provided in the vicinity of the backup roll 23.

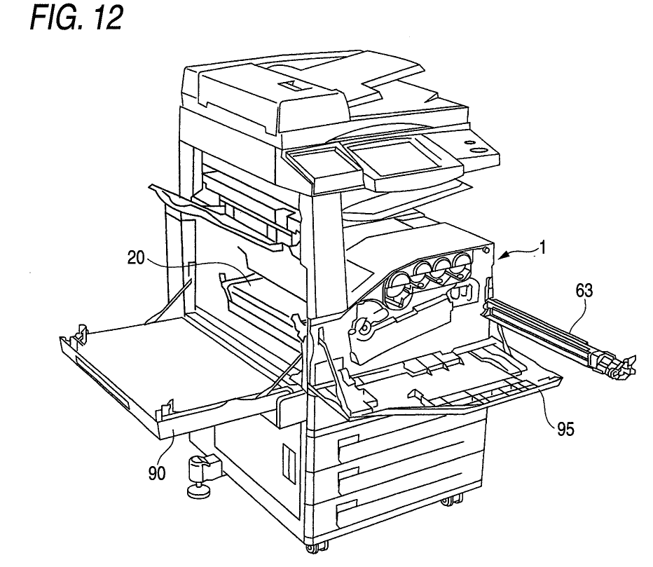

In mounting the intermediate transferring body unit 80 into the digital color multi function machine body 1, as shown in FIG. 12, in a state where an outer cover 90 attached to the side of the machine body 1 is open, the two guide pins 85, 86 of the intermediate transferring body unit 80 are engaged in the guide groove 87 of the guide rail 83, 84 of the machine body 1. Thereafter, as shown in FIG. 12, since the intermediate transferring body unit 80 is pushed into the inside of the machine body 1, the two guide pins 85, 86 of the intermediate transferring body unit 80, as shown in FIG. 11, are guided in the nearly horizontal direction along the first segment 87a of the guide groove 87 of the guide rail 83, 84. At the end of the inlet side of the guide groove 87 for the guide rails 83, 84, a hill-like projection 87d is formed to prevent the guide pins of the intermediate transferring body unit 80 from inadvertently falling away from the guide groove 87 of the guide rail 83, 84.

Further, as shown in FIG. 11, when the intermediate transferring unit 80 is deeply pushed in the inside of the digital color multi function machine body 1, two guide pins 83, 84 of the intermediate transferring body unit 80 are moved from the first segment 87a of the guide groove 87 of the guide rail 83, 84 to the second segment 87b thereof. Then, since the second segment 87b of the guide groove 87 of the guide rail 83, 84 is inclined with respect to the first segment 87a and oriented in the direction inclined so that the right end becomes high by a prescribed height, the direction being a direction of guiding the intermediate transferring belt 20 of the intermediate transferring body unit 80 to an operating position of the multi function machine body 1, the intermediate transferring body unit 80 is guided in its inclined state along the second segment 87b of the guide groove 87 of the guide rail 83, 84. As a result, the intermediate transferring belt 20 of the intermediate transferring body unit 80 is guided to the operating position of the multi function machine body 1.

At this time, in the state where the intermediate transferring body unit 80 is guided along the second segment 87b of the guide groove 87 of the guide rail 83, 84, a half or more part of the intermediate transferring body unit 80 has been inserted into the multi function machine body 1. Therefore, the intermediate transferring unit 80 projected outwardly from the multi function machine body 1 will not interfere with the member such as the outer cover 90.

In the state where the mounting of the intermediate transferring unit 80 in the digital color multi function machine has been completed, the positioning pin 88 of the intermediate transferring body unit 80 is fit in a positioning groove 91 of the guide rail 83, 84 so that the intermediate transferring body unit 80 is positioned at a predetermined position of the digital color composite machine body 1. Further, as shown in FIG. 10, fitting components 92 are fit into the digital color composite machine 1. Thus, the mounting operation of the intermediate transferring body unit 80 is completed.

The operation of removing the intermediate transferring body unit 80 will be carried out in the process opposite to the above mounting operation.

As shown in FIG. 12, on the one side (left side in the figure), the tandem digital color composite machine body 1 is provided with an outer cover 90 serving as an opening/closing member for attaching/detaching the intermediate transferring body unit 80. The outer cover 90 permits, in its opened state, the intermediate transferring body unit 80 to be attached or detached. So, the secondary transferring roll 27 in contact with the backup roll 23 which stretches the intermediate transferring belt 20 and the double-sided transporting unit 50 are assembled integrally with the side cover roll 27. In the state where the side cover is open, as shown in FIG. 12, the area of the intermediate transferring belt 20 stretched by the backup roll 23 is exposed to the outside.

Further, in this embodiment, in controlling the stopping position of the intermediate transferring belt 20, regardless of whether or not the detection signal outputted from the reflective optical sensor 71 is normally outputted, when the outer cover 90 for maintenance is opened, the control circuit 75 always stops said intermediate transferring belt 20 at a position where the reference seal 70 formed on the surface of said intermediate transferring belt 20 is exposed to the outside, i.e. at the position where the reference seal 70 is moved to the area stretched by the backup roll 23.

In the configuration described above, in accordance with the digital color composite machine according to this embodiment, in the following manner, as compared with the prior arts described above, it is possible to prevent malfunction due to contamination of the reference position marking member while avoiding cost increase due to an increase in the number of components such as a brush for cleaning.

Specifically, in the digital color composite machine according to this embodiment, as shown in FIG. 1, the intermediate transferring belt 20 is driven by the drive roll 22 so as to circulate so that, on the intermediate transferring belt 20, the toner images formed by the four image forming units 13Y, 13M, 13C, 13K of yellow, magenta, cyan, black are superposedly transferred, or otherwise the toner image of a predetermined color formed by any of one to three image forming units of the four image forming units 13Y, 13M, 13C, 13K of yellow, magenta, cyan, black is transferred, thereby forming the image of full color or monochrome.

In this case, the respective toner images of yellow, magenta, cyan and black are transferred and a toner patch for adjustment of image quality is transferred on the intermediate transferring belt 20. Thus, the toners, although very little, may be deposited on the surface of the reference seal 70 formed at the end in the axial direction of the surface of the intermediate transferring belt 20. As a result, while the above digital color composite machine is employed for a long time thereby to repeat the image forming operation, the quantity of the toners deposited on the surface of the reference seal 70 increases. Accordingly, in detecting the reference seal 70 by the reflective optical sensor 71, the detection signal outputted from the reflective optical sensor 71 may be gradually deteriorated, and eventually, the output value of the detection signal may be lower than a prescribed value, thereby making it impossible to detect the reference seal 70.

In order to obviate such inconvenience, in this embodiment, as shown in FIG. 1, where the intermediate transferring belt 20 is stopped after the image forming operation is completed, in controlling the stopping position of the intermediate transferring belt 20, regardless of whether or not the detection signal outputted from the reflective optical sensor 71 is normally outputted, when the outer cover 90 for maintenance is opened, the control circuit 75 always stops said intermediate transferring belt 20 at a position where the reference seal 70 formed on the surface of said intermediate transferring belt 20 is exposed to the outside, i.e. at the position where the reference seal 70 is moved to the area stretched by the backup roll 23.

For this purpose, in this embodiment, as shown in FIG. 8, after the control circuit 75 is supplied with the detection signal outputted from the reflective optical sensor 71, it causes the incorporated timer to start the counting. In the course of time, the reference seal 70 passes the reflective optical sensor 71 and the intermediate transferring belt 20 makes one orbit. When the reference seal 70 is moved to the secondary transferring position, the intermediate transferring belt 20 is stopped.

If the moving speed of the intermediate transferring belt 20 is 175 mm/sec, the time taken for the intermediate transferring belt 20 to make an orbit is 872 mm/175 mm/sec=5000 msec. Further, the length L along the orbit of the intermediate transferring belt 20 from the reflective optical sensor 71 to the secondary transferring position is about 83 mm. Therefore, as shown in FIG. 8, the control circuit 75, in its stopping mode, controls the driving motor 73 so as to stop the intermediate transferring belt 20 after 955 mm (872 mm+83 mm)/175 mm/sec=5460 msec passes from when the detection signal outputted from the reflective optical sensor 71 is inputted to the control circuit 75.

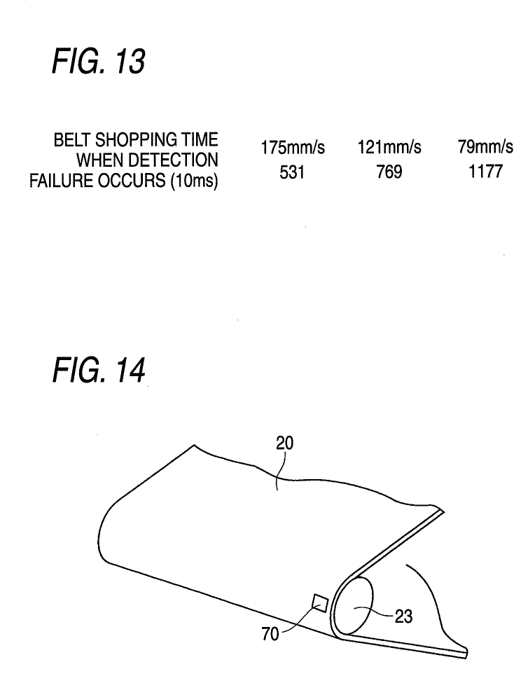

However, considering the moving distance of the intermediate transferring belt 20 due to inertia rotation after the driving motor 73 has been stopped by the control circuit 75, the stopping time of the intermediate transferring belt 20 is set as shown in FIG. 13.

In accordance with this embodiment, as shown in FIG. 1, in the state where the intermediate transferring belt 20 stops, when the outer cover 90 for maintenance is opened, as shown in FIG. 14, the reference seal 70 formed on the intermediate transferring belt 20 is present at the position exposed to the outside. So, when a service engineer visits to an user to perform the maintenance operation of the digital color composite machine, he can instantly perform the cleaning operation for the reference seal 70 formed on the surface of the intermediate transferring belt 20.

As a result, in the above digital color composite machine, when the service engineer visits to the user to perform the maintenance operation of the digital color composite machine, in case of necessity, he can perform the cleaning operation for the reference seal 70 formed on the surface of the intermediate transferring belt 20 so that the surface of the reference seal 70 can be kept in a clean state permitting the reflective optical sensor 71 to surely detect it.

The service engineer visits at irregular intervals to the user employing the digital color composite machine. However, it is known that erroneous detection of the reference seal 70 by the reflective optical sensor 71 due to deposition/accumulation of the toners on the surface of the reference seal 71 does not occur in a short time after use of a new digital color composite machine is started, but first occurs after it is employed for a relatively long time. For this reason, while the user employs the digital color composite machine, before the erroneous detection due to accumulation of the toners on the surface of the reference seal 70 occurs, the service engineer inevitably visits the user several times. When the service engineer visits the user, if he carries out the cleaning operation for the surface of the reference seal 70, the malfunction due to the erroneous detection of the reference seal 70 can be surely prevented.

### Embodiment 2

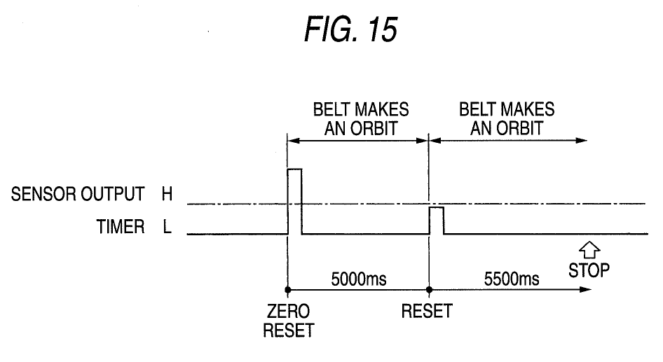

FIG. 15 explains the second embodiment of this invention. The second embodiment with like reference symbols referring to like parts in the first embodiment includes an endless intermediate transferring belt to which a toner image is transferred according to image information; a reference position marking member formed on the surface of the intermediate transferring belt, which is used to mark the reference position in a circumferential direction of the intermediate transferring belt; a detecting unit for detecting the reference position marking member formed on the surface of the intermediate transferring belt; and a control unit for controlling the stopping position of the intermediate transferring belt so that the intermediate transferring belt always stops at a position where the reference position marking member formed on the surface of the intermediate transferring belt is exposed to the outside when a outer cover is opened at the moment when a detection signal outputted from the detecting member becomes a prescribed threshold value or less.

Specifically, in the second embodiment, as shown in FIG. 15, the control circuit 75 always monitors the output signal from the reflective optical sensor 71 to determine whether the output signal from the reflective optical sensor 71 exceeds a threshold value or is not larger than the threshold value. Only if it is determined that the output signal from the reflective optical sensor 71 becomes not larger than the threshold value, after 955 mm (872 mm+83 mm)/175 mm/sec=5460 msec passes from when the detection signal outputted from the reflective optical sensor 71 is inputted to the control circuit 75, the control circuit 75 controls the driving motor 73 so as to stop the intermediate transferring belt 20.

The control circuit 75, if the output signal from the reflective optical sensor 71 exceeds the threshold value, stops the intermediate transferring belt 20 at a normal stopping position.

In this case, in the state where the output signal from the reflective optical sensor 71 exceeds the threshold value, the stopping position of the intermediate transferring belt 20 can be determined preferentially to other conditions such as shortening the completing time of the image forming operation.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. An image forming apparatus comprising:
an endless intermediate transferring belt to which a toner image is transferred;
a reference position marking member that is formed on a surface of the intermediate transferring belt, and that shows a reference position in a circumferential direction of the intermediate transferring belt;
a detecting unit that detects the reference position marking member; and
a control unit that controls the intermediate transferring belt to stop at a position where the reference position marking member is exposed to outside in a case where an outer cover is opened.

2. The image forming apparatus as claimed in claim 1, further comprising:
at least one image forming unit that forms a toner image.

3. The image forming apparatus as claimed in claim 2,
wherein
the at least one image forming unit comprises:
a first image forming unit that forms a yellow toner image;
a second image forming unit that forms a magenta toner image;
a third image forming unit that forms a cyan toner image; and
a fourth image forming unit that forms a black toner image.

4. The image forming apparatus as claimed in claim 1,
wherein
the endless intermediate transferring belt is suspended in a tensioned state by a drive roll, a backup roll and a tension roll.

5. The image forming apparatus as claimed in claim 1,
wherein
the detecting unit comprises a reflective optical sensor.

6. The image forming apparatus as claimed in claim 1,
wherein
the endless intermediate transferring belt is arranged in a state inclined with respect to a horizontal direction so that a lower side traveling area of the endless intermediate transferring belt is lower at a downstream side along a traveling direction and higher at an upstream side.

7. An image forming apparatus comprising:
an endless intermediate transferring belt to which a toner image is transferred;
a reference position marking member that is formed on a surface of the intermediate transferring belt, and that shows a reference position in a circumferential direction of the intermediate transferring belt;
a detecting unit that detects the reference position marking member; and
a control unit that controls the intermediate transferring belt to stop at a position where the reference position marking member is exposed to outside in a case where an outer cover is opened at the moment when a detection signal outputted from the detecting member becomes a prescribed threshold value or less.

8. The image forming apparatus as claimed in claim 7, further comprising:
at least one image forming unit that forms a toner image.

9. The image forming apparatus as claimed in claim 7,
wherein
the at least one image forming unit comprises:
a first image forming unit that forms a yellow toner image;
a second image forming unit that forms a magenta toner image;
a third image forming unit that forms a cyan toner image; and
a fourth image forming unit that forms a black toner image.

10. The image forming apparatus as claimed in claim 7,
wherein
the endless intermediate transferring belt is suspended in a tensioned state by a drive roll, a backup roll and a tension roll.

11. The image forming apparatus as claimed in claim 7,
wherein
the detecting unit comprises a reflective optical sensor.

12. The image forming apparatus as claimed in claim 7,
wherein
the endless intermediate transferring belt is arranged in a state inclined with respect to a horizontal direction so that a lower side traveling area of the endless intermediate transferring belt is lower at a downstream side along a traveling direction and higher at an upstream side.
